(19) United States
(12) Patent Application Publication
(10) Pub. No.: US 2006/0117174 A1
(43) Pub. Date: Jun. 1, 2006

(54) Method of auto-configuration and auto-prioritizing for wireless security domain

(75) Inventor: Chih-Fang Lee, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Arcadyan Technology Corporation

(21) Appl. No.: 10/999,010

(22) Filed: Nov. 29, 2004

(51) Int. Cl. H04L 9/00

(52) U.S. Cl. 713/154

(57) ABSTRACT

The present invention provides an optimization routing method for a communication network comprising obtaining a MAC address & SSID of an access point and encrypting a security key for network traffic by the obtained MAC address & SSID. Then, the client terminal accesses the network through the access point with an authentication key. An individual key is generated after the authentication key is approval. Next, the user designates a priority channel to a priority domain for priority traffic.

### FIELD OF THE INVENTION

The present invention relates to communications network, more particular, to a method of auto-configuration and auto-prioritizing for wireless security network.

### BACKGROUND OF THE INVENTION

Typical wireless or wired network systems comprise one or more devices for communication purposes. The users may be communicated with the router device with personal computers or notebook computers via wireless or wired means. Fixed relay and routing assignments prevent adapting to dynamic network connectivity changes and results in less reliable message delivery. As known, the data may be transmitted in various formats and the various types of telecommunications systems have been installed for transmission of data over numerous media. For example, data may be transmitted from one user to another by leased lines, cellular networks, satellite network, and internet. Networks can vary because of changing populations due to new platform entries and exits. Rigid routing may also lead to a limited number of high density traffic patterns. Concentrated relay transmissions can lead to easier platform detection by intercept receivers and subsequent jamming will lead to large disruptions of network communications. Also, the overloading of a platform's terminal resources with non-adaptive redundant routing leads to underutilization of network capacity and, hence, increased message delay.

Modern high speed networking protocols provide both quality and bandwidth guarantees to every transport connection established across the network. In such high speed packet switching networks, many different classes of traffic share the common transmission resources. The network must therefore be capable of providing traffic generated by a wide range of multimedia services such as text, image, voice and video. The traffic characteristics of such different sources vary dramatically from one another and yet the network must provide a bandwidth and a quality of service guaranteed for each and every connection that is established across the network. It is therefore essential to provide a technique for characterizing the traffic on a high speed switching network which is, on the one hand, simple and easy to measure or calculate and, on the other hand, which captures all of the significant parameters of each of the widely diverse traffic sources. Current wireless systems, most notably 802.11 wireless local area network (“WLAN”) systems, operate in half-duplex mode on a single frequency. That is, the mobile station in a wireless system either transmits or receives at any given time, not both simultaneously. Further, the mobile stations typically operate on a single frequency. Once a mobile station is on a frequency, it stays on that frequency.

The setting of a secure WLAN environment is a major and difficult issue. The infrastructure mode includes AP and Client, both of which need to setup with either Wep key or WPA key. However, it is difficult to setup the Wep key or WPA for a common user who lacks of professional wireless domain knowledge. It is more significant when the input device is a remote control rather than a full function key-board, it is unlikely for the user to set a correct SSID and the security key.

What is desired is provide a new algorithm which can allow the user to enjoy or utilize, friendly, the secure wireless environment, without setting the SSID and the security key.

### SUMMARY OF THE INVENTION

The purpose of the present invention is to provide an auto-configuration method for a wireless security domain of a communication network.

The purpose of the present invention is to provide an auto-prioritizing method which provide auto-negotiation mechanism to link different priority level between client terminal and access point for a wireless security domain of a communication network.

The present invention provides auto-prioritizing method by an auto-configuration for a wireless security domain. The auto-prioritizing method of security domain for communication network comprises steps of associating to the corresponding wireless priority domain based on application type; obtaining a wireless security key for network traffic by said authentication result and designating a priority channel to a priority domain for priority traffic.

The auto-priority method comprises steps of obtaining capability of Access point. The capability includes how many SSID domains or how many frequency channels it can support, what is the priority and bandwidth limitation for each SSID domain or each frequency channel, how many users already associate with this domain or channel, what is the traffic status. With those information, client terminal can select one SSID domain or frequency channel to associate with base on its application type.

The present invention discloses a prioritizing traffic method for security domain of a communication network, comprising steps of obtaining a MAC address of the access point and obtaining a wireless security key based on the obtained MAC address. An encrypting step is performed to encrypt a security key for network traffic. Next steps include accessing the network through the access point with an authentication key and to generate an individual key after the authentication key is approval. Then, nest step is to transfer the individual key to a user and to designate a priority channel to a priority domain for priority traffic.

The next is to send command to force router to use PPPOE pass through mode and start the PPPOE section. Subsequently, sending the PPPOE request to a server and waiting for the PPPOE reply. Next step is to force the router to use a PPPOE authentication key as the security key and change the security key to the authentication key.

The security key encryption is based on the MAC address with RC4 encrypt method, DES/3DES/AES encrypt method and the MAC address is obtained by site survey function. Wherein the authentication procedure is performed from a remote server and the method further comprises a step of informing the user's terminal after the connection is established between the access point and an internet. Wherein the security key is generated for each client terminal based on an authentication result and an authentication method is PPPOE or 802.1x. The priority domain includes management SSID, Voice SSID, Video SSID and Data SSID. Further, the management SSID, Voice SSID, Video SSID, Data SSID are hidden to the user.

The priority traffic is separate by different SSID access automatically and the security key is defined from client site authentication result. The capability of the access point is obtained from multiple SSID or multiple channels information with different priority level. A SSID extension is obtained by an auto-negotiation of the capability of the access point. Wherein the capability of the access point is obtained from auto-negotiation including bandwidth limitation, quantity of client and load of traffic for each SSID or each frequency channel.

### BRIEF DESCRIPTION OF THE DRAWINGS

FIG. 1 illustrates a block diagram of the auto-configuration & according to the present invention.

FIG. 2 illustrates a block diagram of a traffic priority according to the present invention.

FIG. 3 is a flow chart of the present invention.

FIG. 4 is a flow chart according to the present invention.

### DETAILED DESCRIPTION OF THE PREFERRED EMBODIMENT

The present invention provides a method and a means for providing communication in a secure wireless network. Especially, the present invention discloses a method of auto-configuration and auto-prioritizing for wireless security domain of communication network. The invention provides a novel algorithm that allow user to utilize a secure wireless environment without setting the SSID and the security key. In the configuration of the WLAN access point (“AP”), the common set of technical characteristics includes frequency, service set identifier (“SSID”), and associations.

Wireless or Wired Communication Network

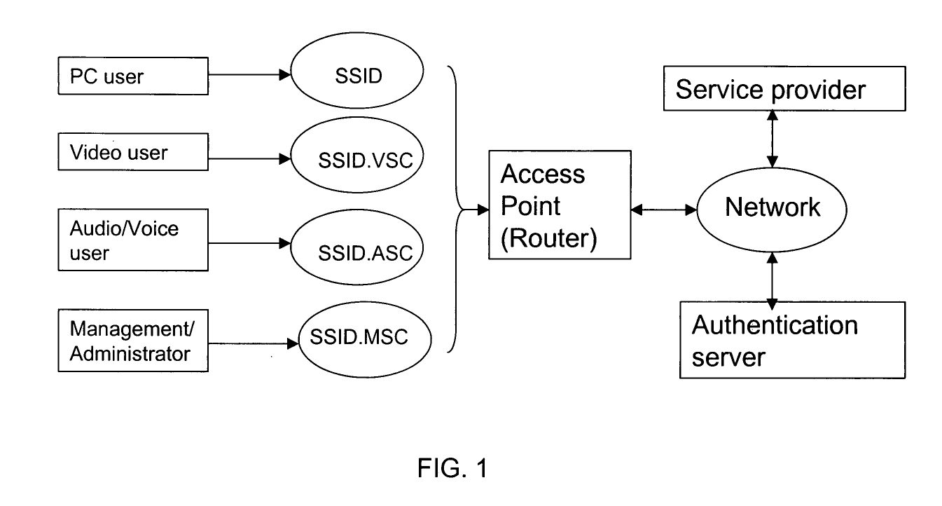

The client terminal may couple to the network through wired port or the access point (AP). As illustrated in FIG. 1, the AP or the router can communicate with at least one of clients during a communication time. The communication network includes a plurality of wireless or wired client's terminals, such as a PC user, a video user, an audio/voice user and a Management/Administrator user coupled to the access point or router by wireless or wired connection. Typically, the PC user uses the SSID channel, the video user utilizes the SSID.VSC channel, the audio/voice user uses the SSID.ASC channel and the Management/Administrator user utilizes the SSID.MSC channel, as shown in FIG. 1. The wireless access point (AP) is capable of relaying the broadcast frame on the wireless network. The access point is equipped and capable of both wireless and wired communication. Through the wired or wireless network, the access point is coupled to one or more service provider or authentication server through the network. Each client may communicate with the AP within an effective range, and the AP communicates to the service provider through the network. Please refer to FIG. 1, the wireless network includes a plurality of IEEE 802.xx capable devices that provide communication for IEEE 802.11a, 802.11b, 802.11g, 802.15 or Bluetooth or even the 3 G or mobile phone device. The client's terminal includes but not limited to laptop computers, PDA (personal digital assistant) or the like. All of the wireless terminals may forward communication message via wireless network to other client or the service provider. The present invention is not directed to controlling the path of the transmission but is concerned with the security wireless environment with the omission of setting the SSID and the security key by the user in the wireless network.

Method of Auto-Prioritizing Traffic

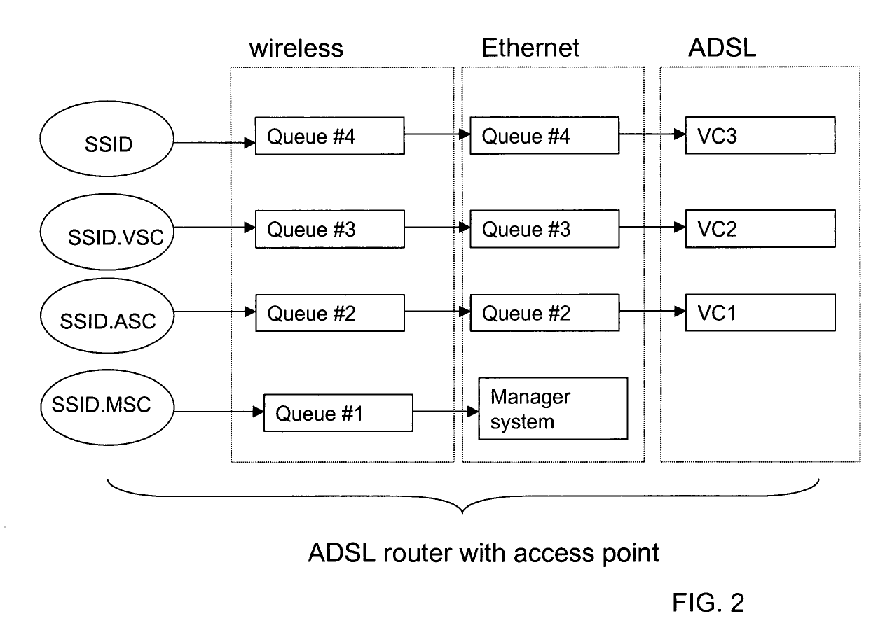

The novel aspect according to the present invention includes a method of auto-prioritizing traffic by auto-configuration in a wireless network for security domain. That is, the method encompasses not only a transmission bandwidth, but also takes into account the traffic priority. In addition, a user's priorities may change from time to time dependent on application type, and the requirements regarding the transmission of one data file may be different than the requirements of another file. Typically, the Broadband device may provide four different types of SSID, one of the SSID types is used for data access. The computer user can configure the SSID through the Web-configuration. The other two types of SSID are set for consumer product. One is for Voice access and the other is for Video access. The last one is reserved for administrator management purpose. The consideration of the transmission (or traffic) priority for the conventional IEEE QoS is packet type. In one aspect of the present invention, the method divides the wireless (or wired) format into four domains defined by SSID or frequency channel, please refer to FIG. 1 and FIG. 2. The aforementioned domains include management domain, voice domain, video domain and data domain. The default priority of the domains from high to low is management domain, voice domain, video domain and data domain in sequence as shown in FIG. 2. but this priority level is not limited to four, it is changeable by the application. To phrase more specified, the transmission priority of the management domain is higher than the one of voice domain, and the transmission priority of voice domain is also higher than the one of video domain. The priority of the video domain is higher than the one of the data domain. It should be noted, the transmission (traffic) priority of the four domains is changeable. If the AP is a device with ADSL capability, the SSID.ASC, SSID.VSC, and SSID can be assigned to the VC1, VC2 and VC3 channel respectively, those VCs have pre-defined priority, so the priority of different SSID need to match to the different VC priority, as shown FIG. 2. The user may alter the priority of the domains depends on the desired. The password can be obtained by virtue of authentication key and then transferring the password for a wireless key. The benefit is that only one set of security key is needed. The transmission priority will not be influenced by the network media no matter it is wireless ADSL or wireless Ethernet.

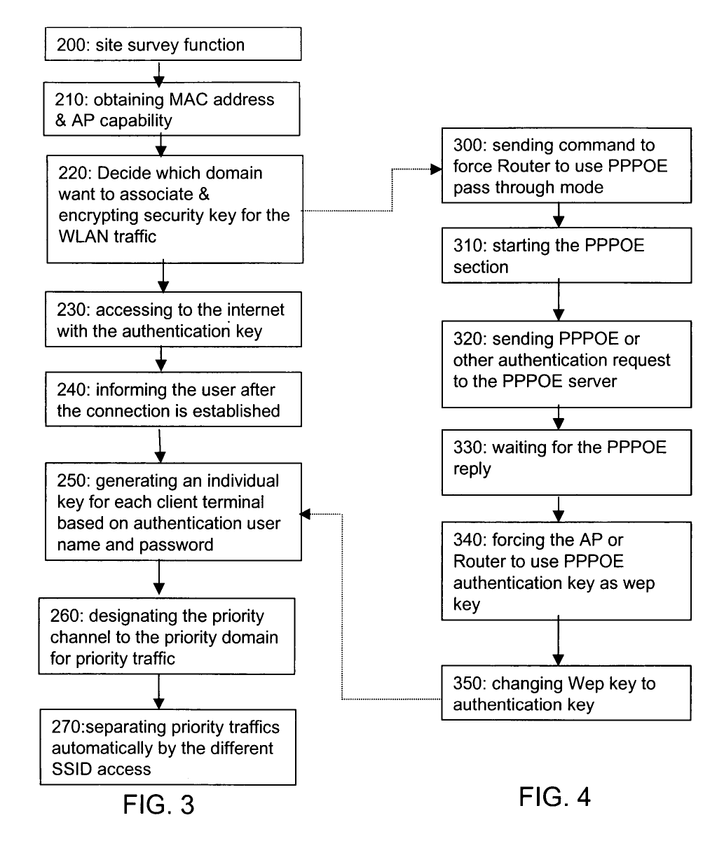

FIG. 3 illustrates a flow chart in accordance with the present invention. The method includes a step of designating traffic (transmission) priority in a wireless (or wired) network for each domain. In some cases, the user may give a name to each domain. For example, the name of the data SSID is configurable by the end user. The name of Video SSID could be set as, for example, the data SSID name+_{┌}VSC (Video Security Channel)_{┌}, by the same way, the name of Voice SSID could be set as the data SSID name+_{┌}ASC(Audio Security Channel), the name of management SSID could be set as the data SSIDname+MSC(Management Security Channel)_{┌}. Those multiple SSID or multiple channels with different traffic priority are included at the AP capability information which client terminal got from auto-negotiation mechanism, others information which client terminal got including the bandwidth allocation, quantity of client & load of traffic at each SSID domain or channel. To simplify the application and not change the computer user behavior, those other SSID domain is hidden to wireless site survey function, but expose at capability negotiation mechanism.

The client terminal decide which SSID or channel to be associated with depend on what is the application running on client terminal. If client terminal is a VOIP device, it will select a voice SSID or channel with high priority to associate with, if client terminal is a set-up box or video application, it will select a video SSID or channel with second priority to associate with. If client terminal is a computer user, it will select a data SSID or channel with low priority to associate with.

If only one AP can be found by the user's terminal, the terminal subsequently connects to the solo AP. On the country, if there is more than one AP that is detected by the client's terminal. Thereafter, a checking procedure is processed to determine which one is connected to the internet. Subsequently, the client's terminal picks one AP that implements the same protocol to connect thereto.

Please refer to FIG. 3, the Voice and Video channel is enabled by a security key and the security key is calculated base on the MAC address & SSID. The security key encryption is based on AP MAC address & SSID with RC4 or other encrypt method. Therefore, the client terminal may be in lieu of site survey function (scan SSID of the AP), step 200, to get MAC address & SSID of the AP device in step 210. Then, the user may encrypt the security key for the WLAN traffic which access to this Voice and Video SSID by the obtained MAC address & SSID in step 220. The Security key could be used to connect the AP.

Turning to FIG. 4, the client terminal sends command to force Router to use PPPOE pass through mode in step 300. If the register is success, the AP informs the client terminal. Then, the PPPOE section is initiated in step 310, followed by sending PPPOE or other authentication request 320 to the PPPOE server. Next step 330 is to wait for the PPPOE reply. If PPPOE connection is success, the command is send by the client terminal to force the Router or AP to use PPPOE authentication key as security key 340. Client terminal also changes Security key to authentication key at the same time automatically 350.

Referencing to FIG. 3, the user may access to the internet through the AP with the authentication key in step 230. An authentication procedure is performed from the remote server. The AP will inform the user's terminal after the connection is established between the AP and the internet while the authentication is approved (240). In one example, the authentication server is located at remote site or the broadband device. The broadband device must have the capability to allow the client terminal to perform the authentication procedure from remote server without any configuration change. After the authentication is success, an individual key is generated, step 250, for each client terminal and the broadband device based on authentication user name and corresponding password.

The individual key is generated from the authentication result and is generated automatically at both client device and broadband device (AP). Then, the generated individual key is transparent to user and will not be configured by the user. The authentication key can be stored at any storage median such as ROM, RAM, Flash, EEPROM, smart card or the like. If the authentication process is failed, both the client device and the broadband device may still use the key which generate from the broadband (AP) device MAC address & SSID. The next step 260 is to designate the priority channel to the priority domain for priority transmission or traffic. When broadband device is capable of supporting the multiple VC with different priority, lower priority traffic which access to Data SSID will go through the Ethernet low priority queue and bound to low priority VC, the higher priority Video traffic which access Video SSID will go through the Ethernet high priority queue and bound to the high priority VC. The second priority Voice traffic which access to Voice SSID will go through Ethernet the second priority queue and bound to second priority VC. The highest priority Management traffic which access to Management SSID will go through Ethernet highest priority queue and bound to highest VC. The priority traffics are separate automatically by the different SSID access in step 270. When a plurality of users access to the same Voice or Video SSID, each user need to be authenticated separately, and use its own key which is automatically generate based on authenticate result. The user may access one's own database through the wireless internet anywhere once the user utilize the same authentication username and password, the wireless network system may allows the user to gain the same secure wireless access through one's private network or through the public network. No further action of user configuration or type of service bit setting is required.

It will be appreciated that the preferred embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

What is claimed is:

1. A auto-prioritizing traffic method for security domain of a communication network, comprising:
obtaining a MAC address & priority level of each SSID of said access point;
designating a priority channel to a priority domain for priority traffic base on application type.
obtaining a wireless security key based on said obtained MAC address & SSID;
encrypting said security key for network traffic;
accessing said network through said access point with an authentication key;
generating an security key after said authentication key is approval;
Communication based on this security key.

2. The method of claim 1, further comprising steps of:
calculating said security key base on said MAC address & SSID;
connecting said user to said access point by said security key;
sending command to force router to use PPPOE pass through mode or use Stun protocol;
starting said PPPOE section;
sending said PPPOE request to a server;
waiting for said PPPOE reply;
forcing said router to use a PPPOE authentication key as said security key; and
changing said security key to said authentication key.

3. The method of claim 1, wherein said security key encryption is based on said MAC address & SSID with RC4 encrypt method.

4. The method of claim 1, wherein said security key encryption is based on said MAC address with DES/3DES/AES encrypt method.

5. The method of claim 1, wherein said MAC address is obtained by site survey function. Priority level of SSID is obtained by auto-negotiation function.

6. The method of claim 1, wherein said authentication procedure is performed from a remote server.

7. The method of claim 1, further comprising a step of informing said user's terminal after the connection is established between said access point and an internet.

8. The method of claim 1, wherein said security key is generated for each client terminal based on an authentication result and an authentication method is PPPOE or 802.1x.

9. The method of claim 1, wherein said priority domain includes management SSID, Voice SSID, Video SSID and Data SSID.

10. The method of claim 1, wherein said management SSID, Voice SSID, Video SSID and Data SSID are hidden to the user.

11. The method of claim 1, wherein said priority traffic is separate by different SSID access automatically.

12. The method of claim 1, wherein a lower priority traffic which access to Data SSID will go through the low priority queue and bound to lower priority VC.

13. The method of claim 1, wherein a higher priority Video traffic which access Video SSID will go through the higher priority queue and bound to the higher priority VC.

14. The method of claim 1, wherein a second priority Voice traffic which access to Voice SSID will go through the second priority queue and bound to second priority VC.

15. The method of claim 1, wherein a highest priority Management traffic which access to Management SSID will go through highest priority queue and bound to highest VC.

16. The method of claim 1, wherein said security key is defined from client site authentication result.

17. The method of claim 1, wherein the capability of said access point is obtained from auto-negotiation including bandwidth limitation, quantity of client and load of traffic for each SSID or each frequency channel.

18. The method of claim 1, wherein a SSID extension is obtained by an auto-negotiation of the capability of said access point.

19. The method of claim 1, wherein the capability of said access point is obtained from multiple SSID or multiple channels information with different priority level.
